(19) United States
(12) Patent Application Publication
(10) Pub. No.: US 2010/0296276 A1
(43) Pub. Date: Nov. 25, 2010

(54) ENERGY SUPPLY DEVICE WITH ENERGY PANELS IN THE FORM OF ROOF TILES

(75) Inventor: Martin Bieri, Rumisberg (CH)

Correspondence Address: OLIFF & BERRIDGE, PLC, P.O. BOX 320850, ALEXANDRIA, VA, 22320-4850, US

(73) Assignee: PANOTRON AG, KIRCHBERG (CH)

(21) Appl. No.: 12/863,605

(22) PCT Filed: Feb. 15, 2009
(86) PCT No.: PCT/EP2009/051742

§ 371 Date: Jul. 20, 2010

(30) Foreign Application Priority Data
Feb. 15, 2008 (EP) 08151538.9

(51) Int. Cl. F21L 4/02; E04D 13/18; F24J 2/04

(52) U.S. Cl. 362/184; 126/622; 126/634

(57) ABSTRACT

The energy supply device having a plurality of energy panels in the form of roof tiles, with which a part of a building is covered and which have an energy module serving to absorb solar energy, which energy module is connected to a power supply line. According to the invention at least one metal pipeline is provided on an outer side of the building, which pipeline carries the energy panels that are mechanically and thermally connected to the pipeline, in which a cable channel, serving to receive the power supply line, and at least one fluid channel are provided, through which a fluid heat transport medium can be conveyed, with which thermal energy can be transferred from the energy panel to a thermal energy sink.

The invention relates to an energy supply device with a plurality of energy panels in the form of roof tiles and also to an energy panel in the form of a roof tile.

Energy panels serve to absorb energy, which is converted in the energy panel into thermal energy and/or electrical energy that is passed to one or more consumer loads. An energy supply device consists of one or more energy panels coupled to each other.

A device with an energy panel is known for example from [1], JP 2005 241021 A. In this panel the thermal energy is removed by means of a pipe structure, which comprises two larger-sized pipes arranged parallel to each other, which are connected to each other with smaller pipes extending perpendicular thereto. The smaller pipes lie directly on the energy panel and carry away the extracted thermal energy via the pipe structure. Such devices are, however, unsuitable for roof structures.

A generic energy panel is known on the other hand from [2], EP 0 335 261 B. This energy panel comprises a body in the form of a roof tile or an outer wall forming member, a plurality of solar cells, each of which is arranged on an outer surface of the tile or wall forming member exposed to sun rays, whereby said energy panel also comprises a passageway for a heat transport medium. Said passageway is disposed below the area of the tile or wall forming member, on which the solar cells are arranged. The body of the energy panel is produced from a composite material of a particle-form, inorganic, granular or fibrous material and a heat conducting metal.

The energy panel known from [2], the principle of which has been well established, and also devices and systems based upon this energy panel have various drawbacks. The integration of the solar cells and the passageway for the energy transport medium into the energy panel result in a relatively complex structure of the energy panel with correspondingly high manufacturing resources being required. The heat medium passageway, a channel or a pipeline, must be embedded in the energy panel and be provided at the inlet and outlet opening thereof with coupling elements, which allow the passageways of a plurality of energy panels to come together to form a single pipeline or a single channel, through which the heat transport medium flows. Insofar as numerous such energy panels are used to cover a roof this results therefore in a high number of coupling points, which must remain leak-tight even after a fairly long operating duration and repeated activation. Furthermore it is to be noted that only relatively thin pipelines can be used. This results in a relatively high line resistance and a correspondingly high line pressure, which places great requirements upon the quality of the coupling points. Should individual coupling points fail, for example after operation over many years, this results in very high maintenance resources being required. On the one hand the fault position needs to be located and on the other hand the defect is to be eliminated with considerable efforts. Furthermore, due to the small diameter of the pipeline only a small quantity of heating medium can flow through the energy panels that are coupled to each other, which means that optimum heat transfer is not guaranteed.

An deficient heat transfer results not only in an insufficient yield of thermal energy but also in non-optimal operation of the energy cells, which output less electrical power at high temperatures.

It is thus the object of the present invention to create an improved energy supply device with at least one energy panel and also to create an improved energy panel.

In particular, it is an object of the present invention to create an energy supply device with at least one energy panel that efficiently converts solar energy into thermal and electrical energy.

It is a further object to allow production, installation and maintenance of the energy supply device and the energy panels with reduced efforts.

In addition, the energy supply device shall provide new and advantageous performance features. In particular, efficient management of the energy supply device shall be possible with minimal resources.

This object is achieved with an energy supply device and an energy panel having the features indicated in claims 1 and 8 respectively. Advantageous embodiments of the invention are indicated in further claims.

The energy supply device comprises a plurality of energy panels provided as roof tiles, with which a part of a building is covered, and which comprise an energy module serving to absorb solar energy. Said energy module is connected to a power supply line.

According to the invention at least one metal pipeline is provided on an outer side of the building, which metal pipeline supports the energy panels that are mechanically and thermally connected to the pipeline. Disposed in said pipeline are a cable channel serving to house the power supply line and at least one fluid channel, through which a fluid heat transport medium can be conveyed, with which thermal energy can be transferred from the energy panel to a thermal energy sink.

The pipeline provided for the heat transport, which is preferably mounted horizontally and is preferably an aluminium profile, replaces a lathing on the roof or a building wall and is for example mounted on the rafters of the roof truss extending perpendicular thereto. The pipeline thus fulfils a dual function. On the one hand it serves for more stable mounting of the energy panels in comparison with wooden lathing. On the other hand it serves for absorbing and carrying away the thermal energy gained from the energy panels. The additional costs resulting in comparison with conventional roof lathing are relatively low and are more than compensated by the reduced production costs for the energy panels. In addition, with the installed pipeline system an extremely stable and reliable construction is obtained that can withstand even the worst weather conditions. An excellent heat transfer is realised due to the relatively large cross-section of the pipeline.

It is also particularly advantageous that with the inventive pipeline system the energy panels, particularly electrical modules provided therein, the building roof or a building wall can be cooled. For this purpose the heat transport medium can be cooled to low temperatures in a cooling zone, for example in the ground, before it reaches the pipelines in the region of the energy panels. This measure facilitates an extremely efficient and cost-effective cooling of the building, meaning that cooling units that usually have high energy consumption are superfluous. For example in the summer the downhole heat exchanger of a heat pump can be used to circulate the heat transport medium.

A particular advantage of the inventive energy supply devices is that the metal pipeline system and the energy panels, consisting at least partially of metal, protect the inhabitants of the respective building against the effects of radiation and electro-smog and can even protect against lightning in corresponding embodiments. Radiation of high frequency waves, which is widely feared today, is thus advantageously averted.

The coupling of the energy panels to the pipeline can be carried out with simple measures, whereby a practically negligible heat transfer resistance results. The thermal energy absorbed by the energy panel is thus efficiently transferred to the pipeline and carried away by the latter. Thus, good cooling of the energy panels is also achieved, meaning that the energy cells, possibly solar cells, can work optimally and output maximum electrical energy.

In a preferred embodiment the pipeline comprises at least one first fluid channel, in which the heat transport medium is conveyed in one direction, and at least one second fluid channel, in which the heat transport medium is returned. A terminating element is thus provided at one end of the pipeline, through which terminating element the heat transport medium arriving from the first fluid channel is conveyed into the second fluid channel. At the other end of the pipeline the heat transport medium can thus be supplied and removed at the same point. In this embodiment of the pipeline the whole pipeline system can be simply planned and constructed. The conveyance of the heat transport medium in both directions within the pipeline also leads to the averaging-out of the temperatures that can arise at different points of the pipeline.

It can be advantageous to divide the pipeline system into segments, which are operated independently of each other each with a respective circulation pump. The segments are preferably formed in such a way that they are assigned to individual zones of the solar radiation. For example a first segment of the pipeline system can be disposed on the south side of the double pitch roof and a second segment on the west wall of a house. The separation of said segments makes corresponding connecting lines unnecessary and is expedient already for this reason alone. However, the separation is also expedient for the reason that the respective segments can be respectively operated at the time at which the optimum solar radiation is available for each segment.

Water is a suitable heat transport medium. However, the advantageous embodiment of the inventive energy supply also allows the use of oil, which has excellent suitability for heat transport.

In order to avoid heat losses the pipeline is preferably provided with an insulation layer, which is preferably only interrupted at the points at which the pipeline is thermally and mechanically coupled to the energy panel. It is ensured in this way that the thermal energy obtained is not lost during transport.

The use of an external pipeline is also particularly advantageous for the reason that it can be provided with a cable channel extending in an axial-parallel way. Said cable channel is preferably incorporated into the body of the pipeline e.g. in the form of a dovetail shaped recess or groove. Provided in this well protected but at the same time easily accessible cable channel, which faces the energy panel, are the power supply lines, with which the electrical energy output by the energy modules is transferred, and possibly data supply lines, in particular control lines, which serve for data transmission between a central control unit and control units which are decentralised or arranged locally in the energy panels. The local control units can also be simple switching units that are controlled by the central control unit in order to convey the current produced by the energy modules to a current collector or a consumer load or storage element that is central or provided locally in the energy panel.

The local control unit is preferably designed, e.g. can be switched by a switch in such a way, that the energy module is connected, after the decoupling of the energy panel from the power line, to respective light emitting diodes, which consume the energy produced and simultaneously indicate the status of the energy panel. The energy panels can thus be operated in an isolated way, controlled by the local control unit, or in a combined way, controlled by the central control unit, so that the energy is not fed to the power line but instead to the consumer loads provided on the energy panel. Staff can thus carry out maintenance work and visual checks upon installed or dismantled energy panels without being exposed to safety risks.

Said lines can be in the form of a flat cable, which is preferably provided with electrical connecters at the necessary intervals, whereby each of said electrical connectors can be connected by means of a further connector to the connection line of an energy panel.

The use of a central control unit and also local control units, which are preferably connected to energy storage elements, light emitting diodes and/or sensors arranged locally on the energy panels, results in numerous further advantageous application possibilities in connection with the inventive energy supply system. With the use of sensors it is possible to ascertain the status of the energy panel and the status of the environment. After transmission of the data ascertained to the central control unit the latter can optimally control the whole system and/or the energy supply device. For example individual segments of the pipeline system can be switched on or off.

The use of at least one energy storage element in each energy panel is particularly advantageous. Using accumulators known today the energy obtained can be locally stored and not output until needed and under optimum conditions. A central energy storage unit may not be necessary. Using accumulators known today, for example lithium ion accumulators, which typically have energy densities of 100 Wh/kg and power densities of 1000 W/k, enormous quantities of energy can thus be stored locally and output when needed. With the aid of the local control units these accumulators can be monitored and kept within an optimum working range, in order for example to prevent a complete discharge thereof. Furthermore the stored electrical energy can be transformed in a preferred form, possibly to higher values, and output in order to reduce losses.

In consideration of the control commands supplied by the central control unit the local control unit can optimise the energy transfer and possibly refuse the energy supply in response to a request for energy if this is necessitated by the circumstances. The local control unit can thus control the power output by the energy modules towards the local energy storage unit provided in the energy panel or towards at least one central current collector. The central current collector can be an accumulator or an energy converter, which outputs alternating current to an internal or external network.

The mechanical and thermal coupling to the pipeline is realised with a coupling device, the elements of which are formed so as to be fully or partially integral with the pipeline or integral with a metal body of the energy panel or can also be provided as separate fittings.

A pipeline having at least one virtually or partially circular cross-section is preferably used so that flanges or clamps lying planar with the pipeline can be turned into a suitable position and connected in a force-locking way with the pipeline with great contact pressure. It is particularly advantageous for coupling elements also to be used that serve for a shape-locking connection. For example toothed elements engaging in each other can be used, which can be fixed in selectable positions.

Insofar as a separate coupling fitting is used this can be optimally adapted, particularly with the greatest possible contact surfaces, on the one hand to the pipeline and on the other hand to the energy panel. At the same time it is easily possible to mount and adjust the separate coupling fitting. Openings are preferably provided in the energy panel, through which tools can be guided, by means of which the coupling device can be securely tightened or released.

In preferred embodiments a metal substrate of an energy module is connected to the pipeline directly or by means of a rigid or flexible metal band. The connection of the metal substrates of the energy modules to the preferably earthed pipeline system additionally results in optimum protection against the effects of radiation and lightning.

Energy panels for the inventive energy supply device, which are provided with one or more energy modules, can be produced and assembled in a simple manner. The energy panels can be optimally prepared for housing of the energy modules and for coupling to the pipeline. Large contact surfaces or the integral formation of the coupling elements on the metal body of the energy panel ensure allow optimal heat transfer.

The energy panels provided for the energy supply device exist in the form of a roof tile. Using the roof tile shaped energy panel the roof truss of a house can thus be designed aesthetically in the conventional way. It is not therefore necessary to set aside the preferences relating to a house with roof tiles that can be made of any given materials. In addition, however, there is the advantage that the roof tiles output the energy in the form of electrical and thermal energy to a consumer load.

An energy panel in the form of a roof tile thus comprises a tile structure made of clay or metal, on the upper side of which a receiving area for the separately placed energy module is provided. However, the tile structure, for example made of clay, and the energy module suited thereto can be produced separately in optimised manufacturing processes.

The tile structure or a roof tile can thus be produced with low costs in a tile factory. The roof tile is thereby preferably designed so that it can be mounted with or without an energy panel. The tile factory can thus produce a single product and deliver it to customers wishing to install an inventive energy supply device as well as those who do not. All the requirements of conventional roof tiles are thus fulfilled by the roof tile produced. There are merely design features present that allow the energy module to be coupled to the new roof tile.

The energy module can also be produced in a specialised factory with optimum efficiency. The energy module preferably consists of different layers, the base layer of which is formed by a metal substrate or a metal body in the form of a metal plate, through which the thermal energy is carried away with the aid of a coupling element through an opening in the roof tile or over the upper edge of the tile that is covered by a further energy panel towards the pipeline. For example the metal substrate comprises a coupling element formed integrally thereon and which is connected to the pipeline. Alternatively the metal substrate can be connected to the pipeline via a metal band and mounting brackets such as buckles or clamps.

The metal body of the energy panel can preferably be connected or is integrally connected to a cooling element and a coupling device, which can be connected to the pipeline in such a way that the thermal energy absorbed by the cooling element can be transferred to the pipeline and the energy panel is kept stable at the same time. The cooling element is preferably thermally and possibly also mechanically closely coupled to the energy module in such a way that said energy module is optimally cooled. The energy module preferably lies against the cooling element with large contact surfaces and is screwed thereto so that the heat transfer resistance between the contact surfaces is negligibly small. In further preferred embodiments the metal body lies planar against the tile structure so that a large proportion of the thermal energy can be transferred via the heated roof tile to the pipeline arranged thereon.

In a first principal embodiment the energy panel comprises a structure having at least one opening, within which the metal body is held by means of a casting compound. For example a clay tile is produced, which comprises at least one opening serving to receive the energy module and the metal body. In a preferred embodiment the metal body and the at least one energy module can also be pre-manufactured as a combined module and incorporated into the clay tile.

In a second principal embodiment the energy panel comprises a metal structure, with which the metal body is integrally connected. For example a metal structure is produced from aluminium, into which metal structure the at least one energy module can be inserted. Furthermore the metal structure can be provided with a large coupling surface for the coupling device or also with a coupling element formed integrally thereon. In both cases the coupling elements can be produced optimally and with limited resources.

The structure present in the form of a tile comprises for example an opening, within which at least one energy module is held by means of the casting compound or fixing elements, for example screws, with the aid of which the energy module is connected to the coupling element.

In particularly preferred embodiments on the other hand the roof tile does not have an opening, meaning that the electrical lines and the thermal coupling elements are guided over the roof tile to the pipeline. This facilitates particularly simple installation of the energy panels and also a modular construction of the energy panel with a roof tile preferably made of clay and an energy module adapted thereto but separately produced.

In this preferred embodiment, holding elements, for example guide grooves, are provided on the tile structure. The energy module can be inserted into said holding elements and is connected, after insertion, preferably via connecting contacts to connection lines. The connection lines are, however, preferably already provided on the energy module so that an optimal electrical contact is guaranteed.

The modular assembly results in minimal production costs and minimal requirement for assembly resources. In case of a technical defect the defective energy module can be removed within seconds and replaced by a new unit. The structure preferably comprises an opening, which can be exposed after removal of the energy modules or by means of a flap, and affords access to coupling elements allowing the energy panel to be mounted or released.

Insofar as the energy panel is to be equipped with a local control unit and/or a local storage unit, it can be provided with a suitable chamber to house these elements. The chamber can be closed by a flap or, particularly advantageously, through the energy module that can be inserted into the holding elements.

The modular construction of the energy panel with a separately produced energy module allows on the other hand the advantageous integration of any electrical components such as solar cells, control units with switching transistors and light emitting diodes. The energy module is preferably produced using SMD (Surface Mounted Design) technology. The electrical components are preferably mounted on an Insulated Metal Substrate (IMS®), which guarantees optimal heat removal to the metal substrate. The integration of light emitting diodes that are exposed and clearly visible after installation of the energy panel is particularly advantageous. For example two parallel chains with a plurality of light emitting diodes arranged in series are provided, which can be connected via the local control unit, in simple embodiments an opto-coupler or switching transistor, optionally to the solar cells in order to check them or to absorb the energy produced. Insofar as the energy panels are not yet installed or the power line is to be voltage-free, the solar cells are preferably connected to said light emitting diodes. Insofar as a chain with light emitting diodes is removed the functioning thereof is assumed by the other chain.

The invention is explained in greater detail below by reference to drawings, in which:

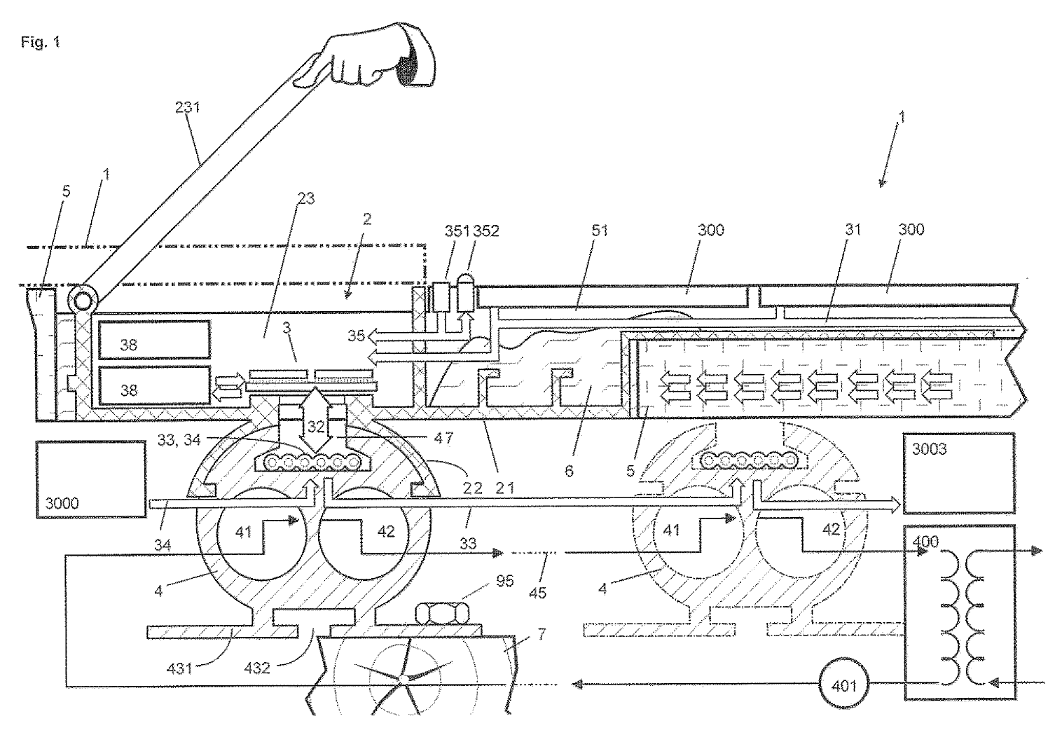

FIG. 1 shows an inventive energy supply system with an energy panel 1, in which a metal body 2 is provided, which is thermally and mechanically coupled to a pipeline 4;

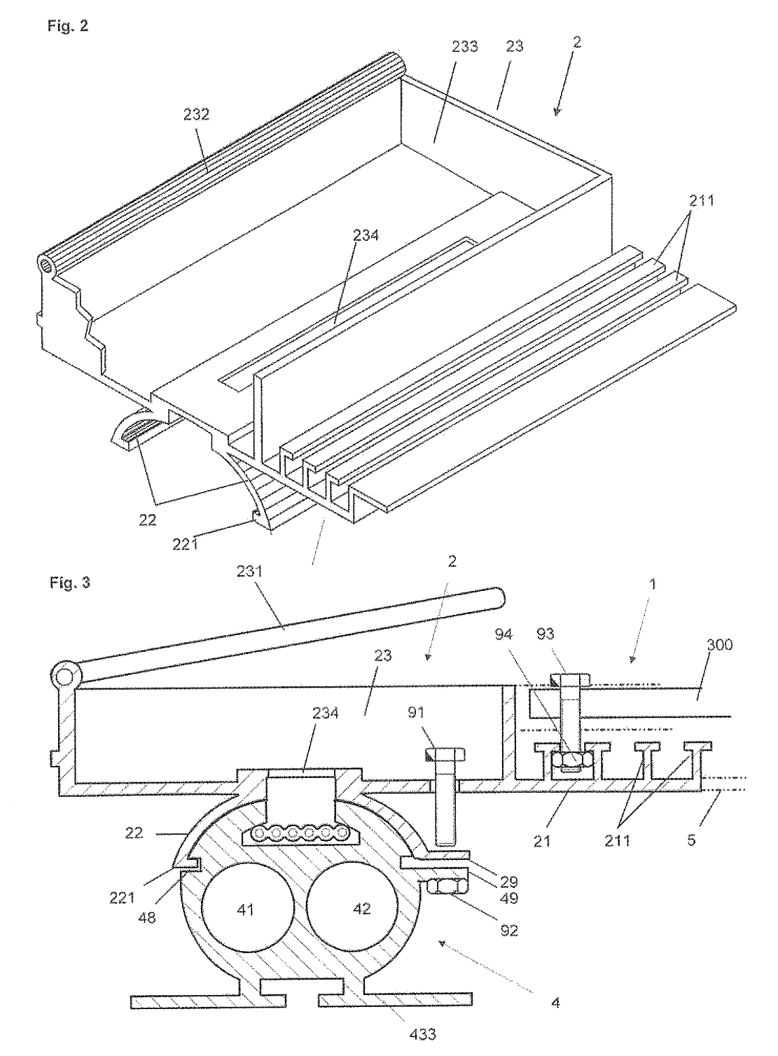

FIG. 2 shows, in a three-dimensional illustration, the metal body 4 of the energy panel 1 of FIG. 1, which comprises a cooling element 21 serving to absorb thermal energy, a coupling element 22, which can be connected to the pipeline, and a chamber 23, which serves to house a control unit 3 and a energy storage element 38;

FIG. 3 the metal body 2 of FIG. 2 in a further embodiment, in which the structure 5 of the energy panel 1 is possibly produced integrally from metal;

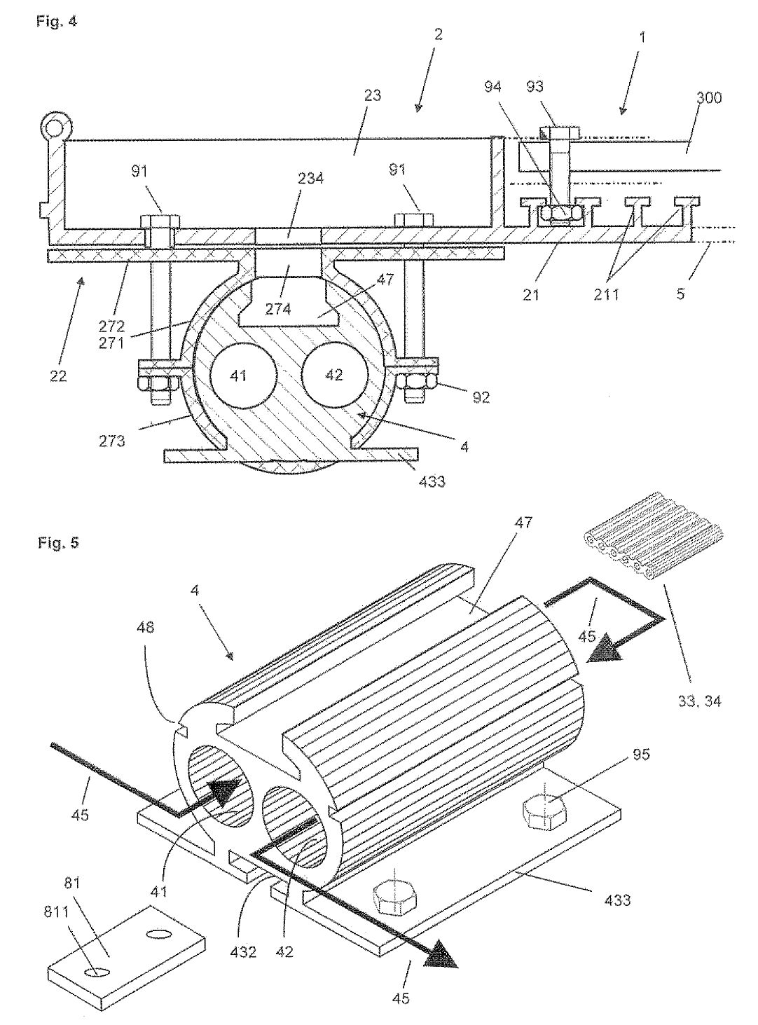

FIG. 4 the metal body 2 of FIG. 2 in a further embodiment, which is connected by means of a coupling fitting 271, 272, 273 to the pipeline 4, which essentially has a circular cross-section;

FIG. 5 in a three-dimensional illustration, a segment of the pipeline 4 of FIG. 1, which comprises two fluid channels 41, 42 serving to convey the heat transport medium and an axially extending dovetail form recess 47, which houses, for example in the form of a flat cable, power lines 33 and control lines 34;

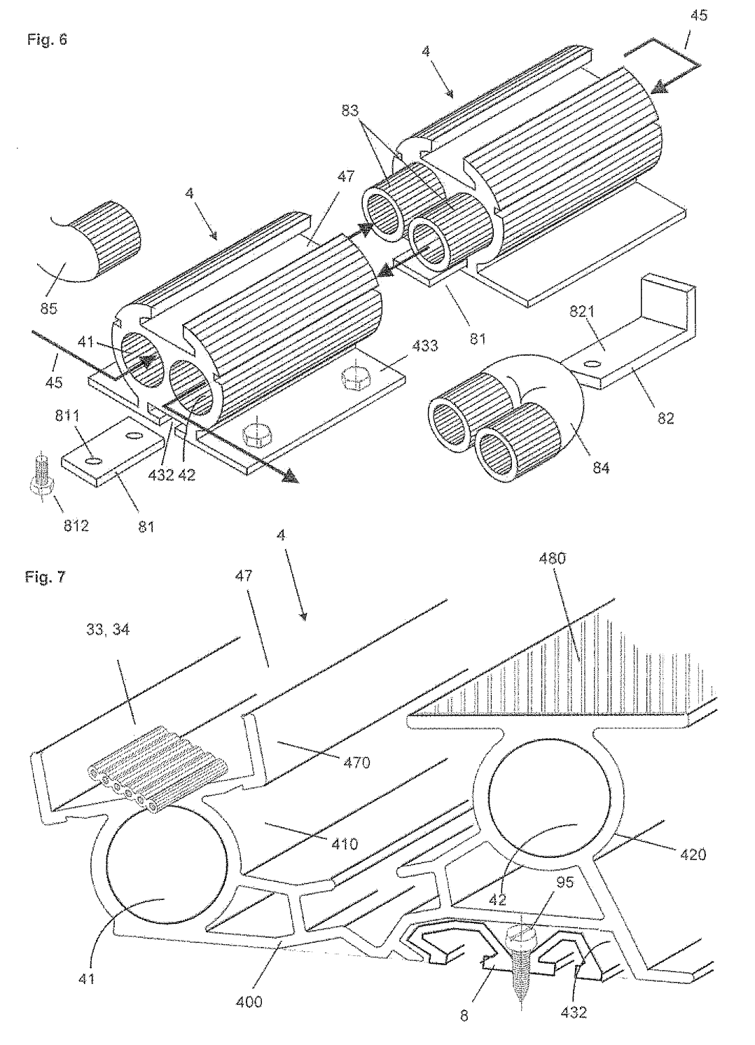

FIG. 6 elements of the pipeline system with segments of pipelines 4 according to FIG. 1, which can be mechanically connected to each other using mounting profiles 81, and of which the fluid channels 41, 42 can be brought together using connecting parts 83, 84, 85 or can be connected to supply and drainage lines;

FIG. 7 a preferably designed pipeline 4 having a profile with two pipe parts 410, 420 connected to each other via a base structure 400, in which pipe parts 410, 420 the first or second fluid channels 41, 42 are guided, whereby on the first pipe part 410 a first profile part 470 guiding the cable channel 47 is arranged and on the second pipe part 420 a carrier plate 480 is arranged, on the top side of which the energy panels 1 can lie planar;

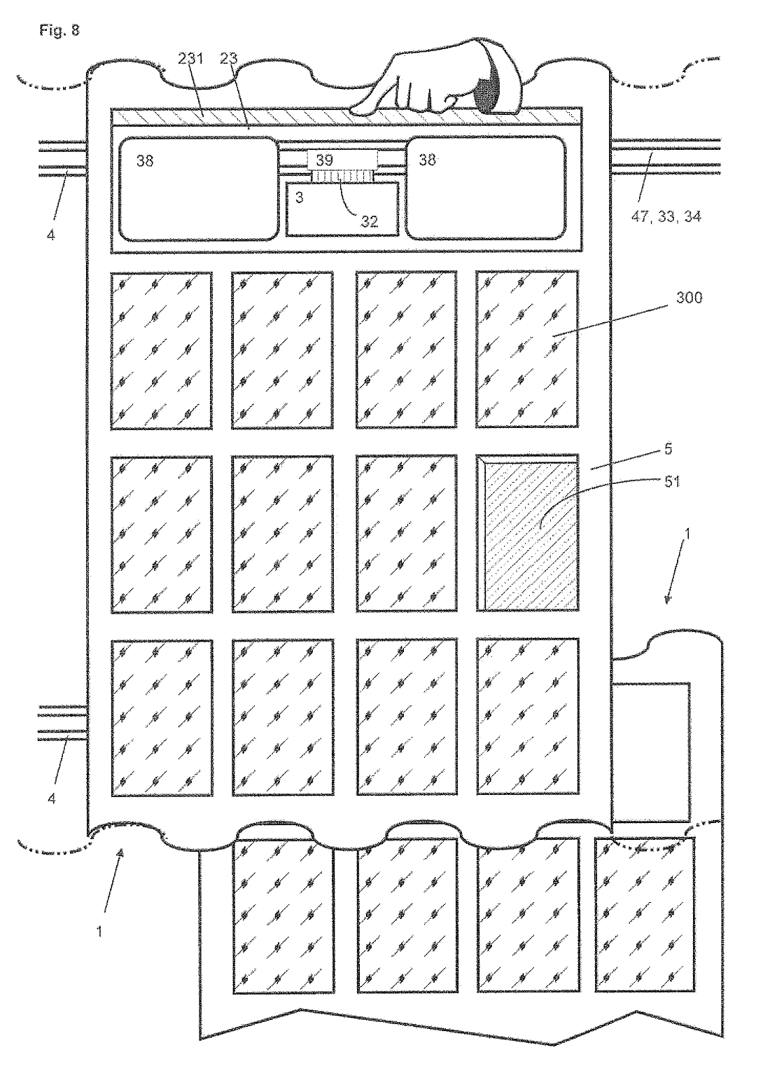

FIG. 8 two energy panels 1 each connected to a pipeline 4 in a first embodiment;

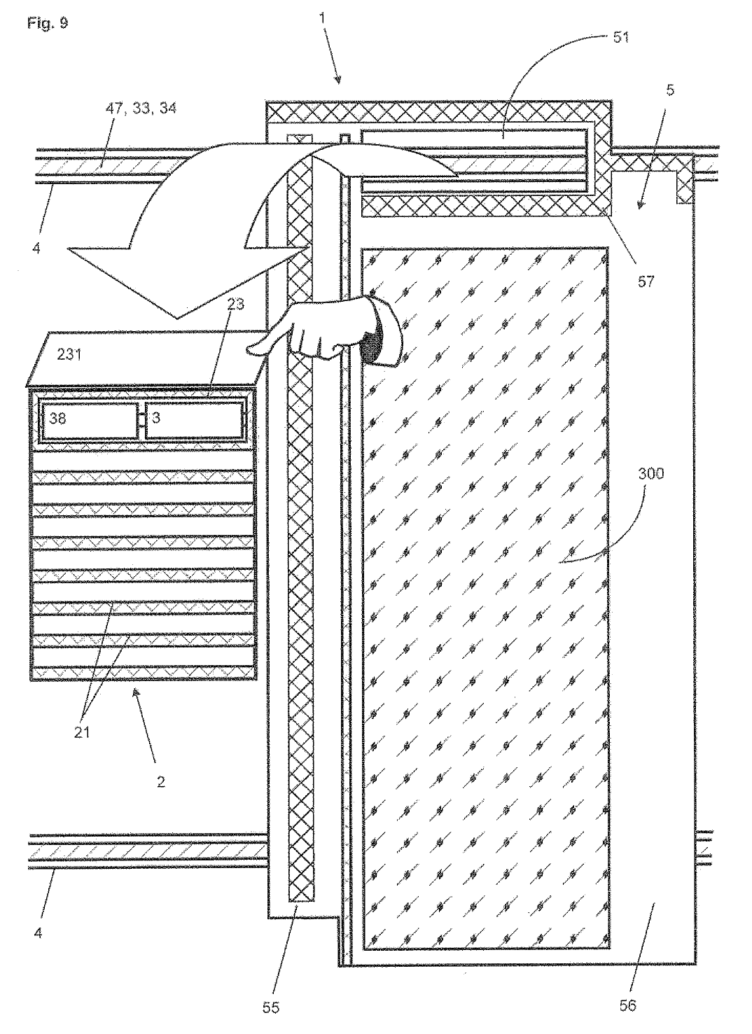

FIG. 9 an energy panel 1 connected to a pipeline 4 in a second embodiment;

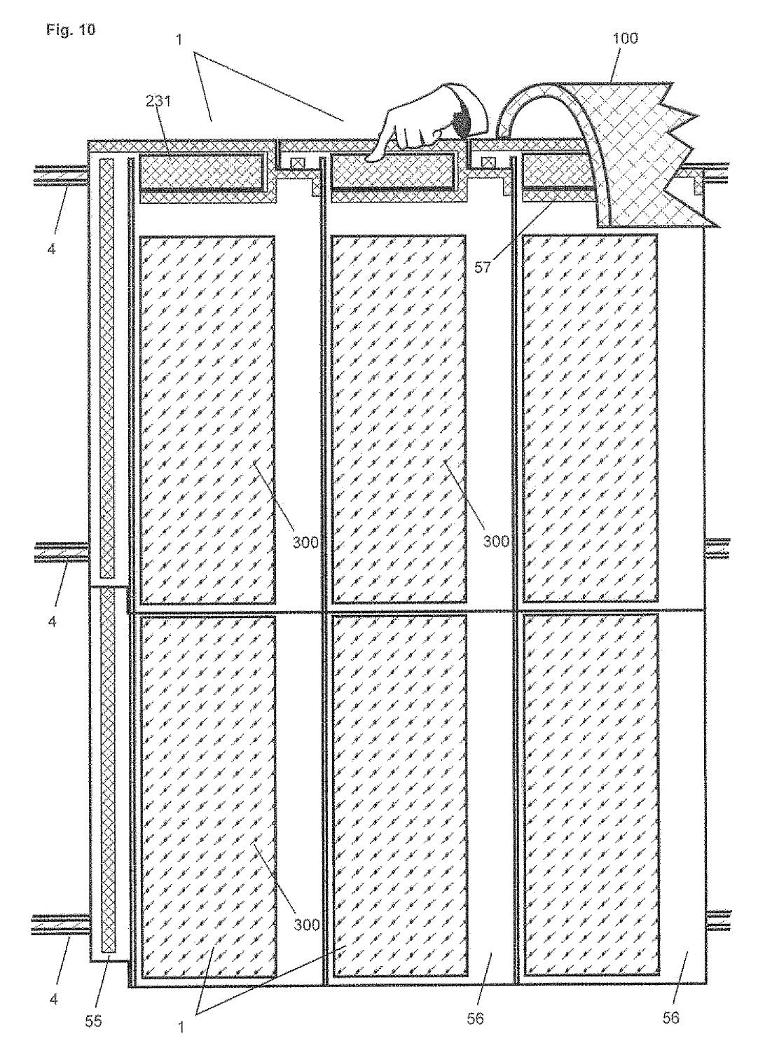

FIG. 10 a plurality of energy panels 1 according to FIG. 5 mounted on pipelines 4 on a roof;

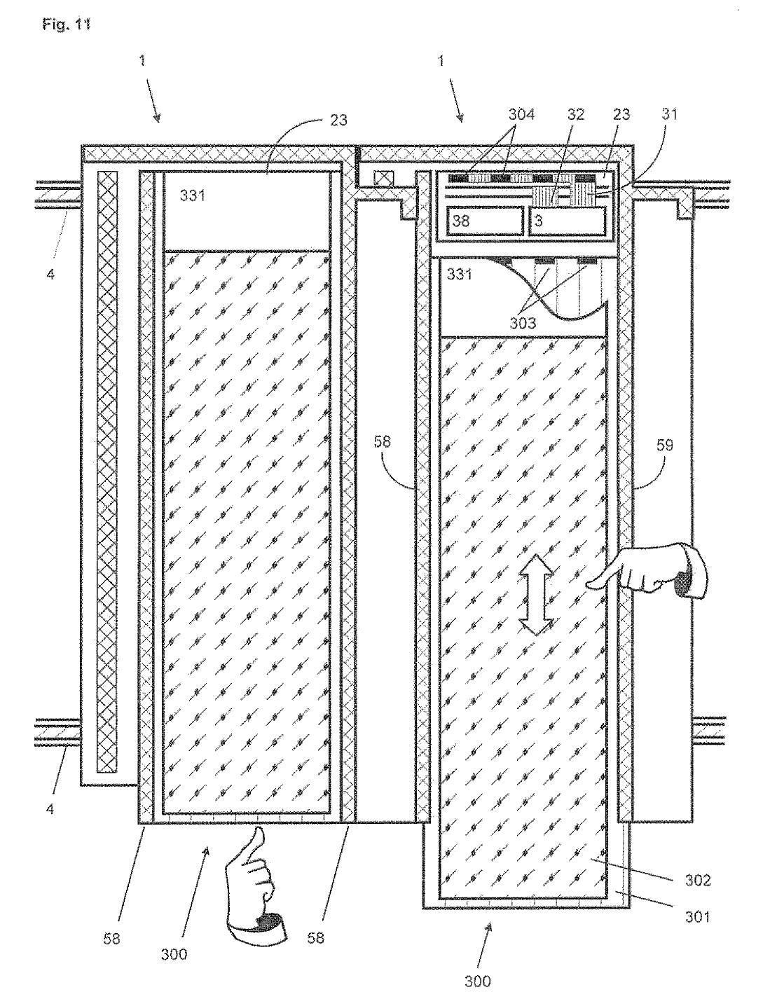

FIG. 11 an energy panel 1 according to FIG. 5, into which an energy module 300 can be inserted;

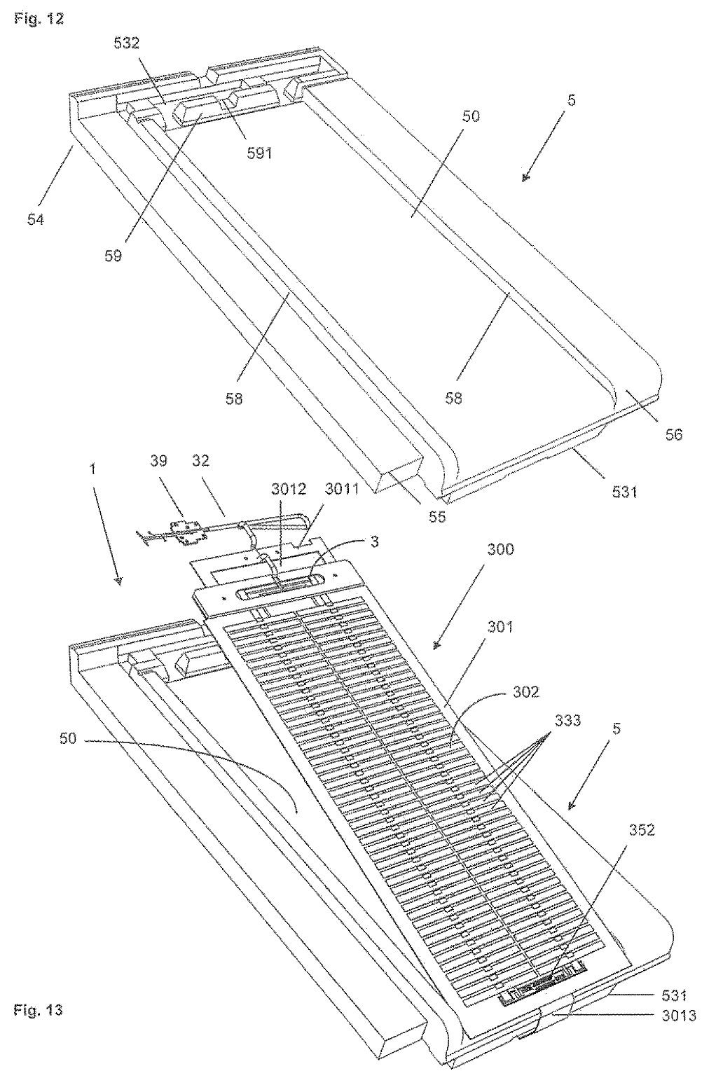

FIG. 12 the structure 5 of a roof tile, upon which an energy module 300 can be placed;

FIG. 13 the structure 5 of the roof tile according to FIG. 12 during the mounting of the energy module 300;

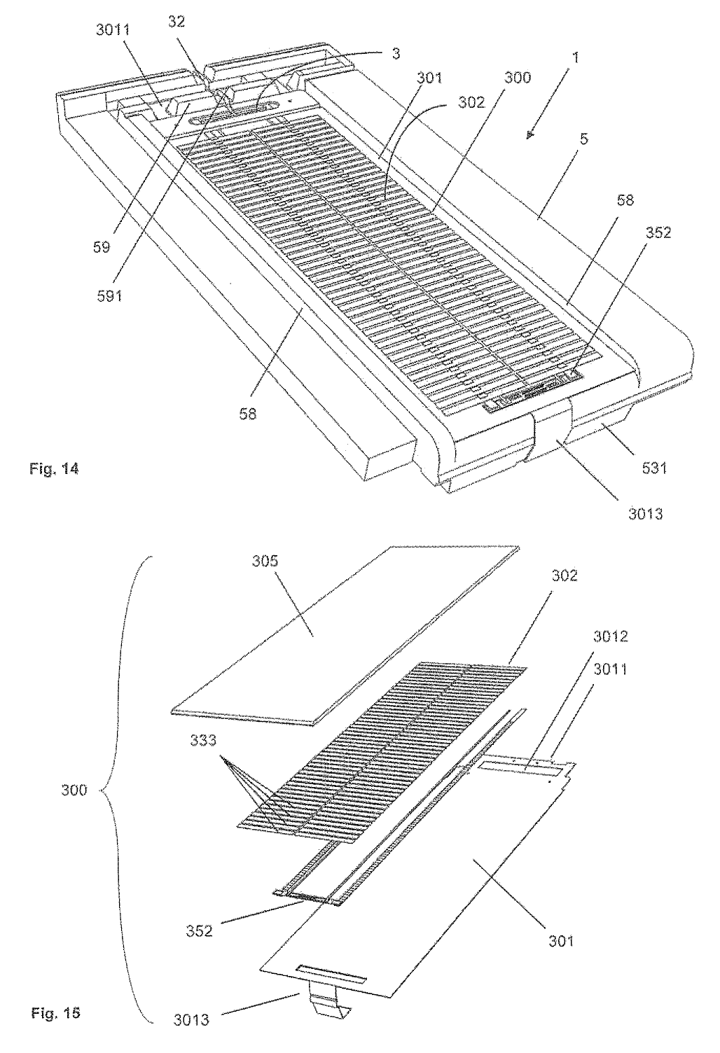

FIG. 14 the energy panel 1 formed by the roof tile 5 and the energy module 300 connected thereto;

FIG. 15 the energy module 300 of FIG. 13 in an exploded view;

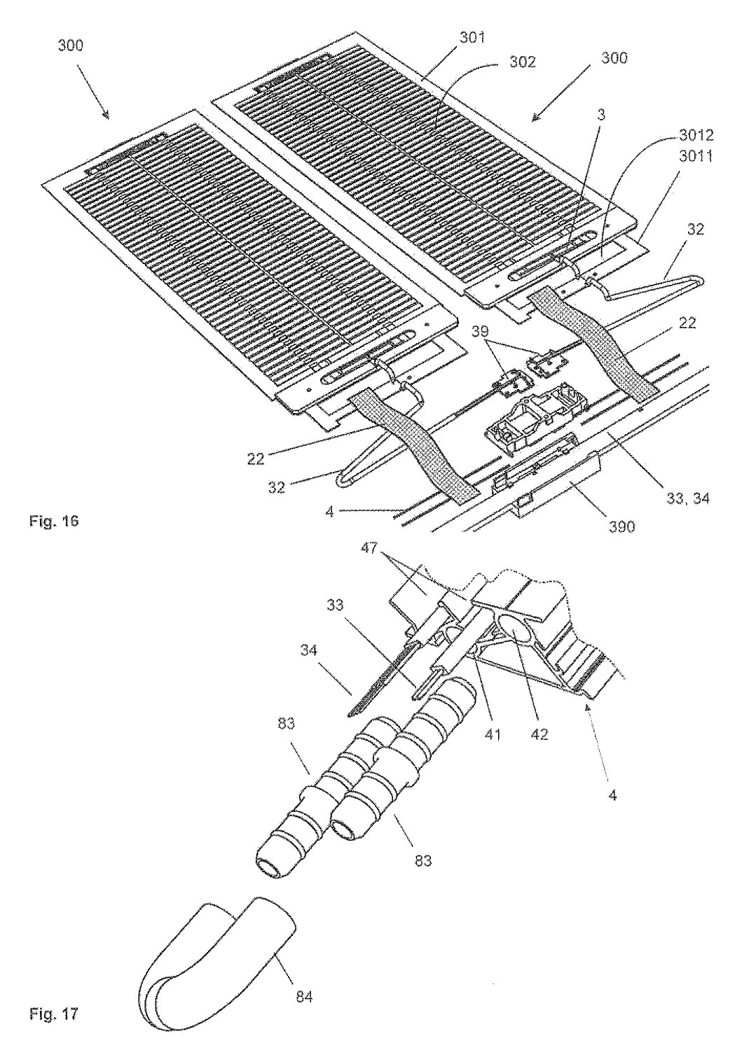

FIG. 16 two energy modules 300, which are electrically connected to a power supply line 33 and control lines 34 by means of connection lines 32 and are electrically and thermally connected to the pipeline 4 by means of coupling devices 22;

FIG. 17 a preferred embodiment of the pipeline 4 of FIG. 7 with two cable channels 47, which serve for the separate guiding of power lines 33 and control lines 34;

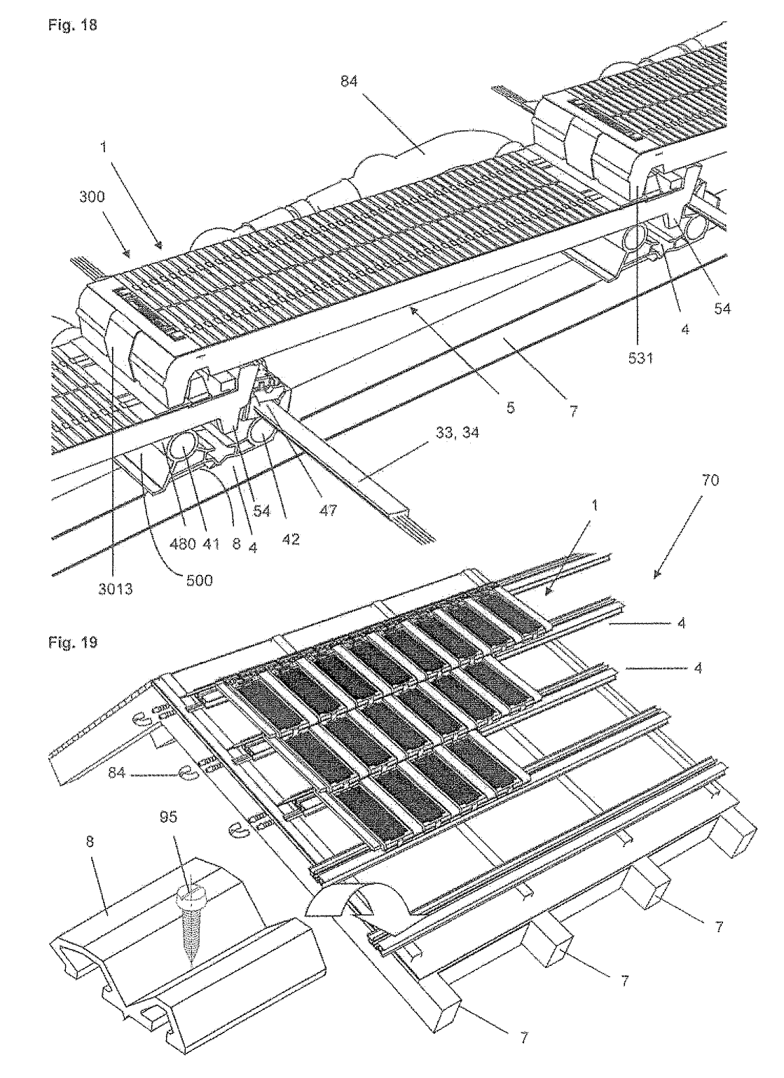

FIG. 18 pipelines 4 mounted on a roof and forming the roof lathing, on which energy panels 1 are arranged;

FIG. 19 the roof level 70 of a building, on which inventive energy panels 1 are installed;

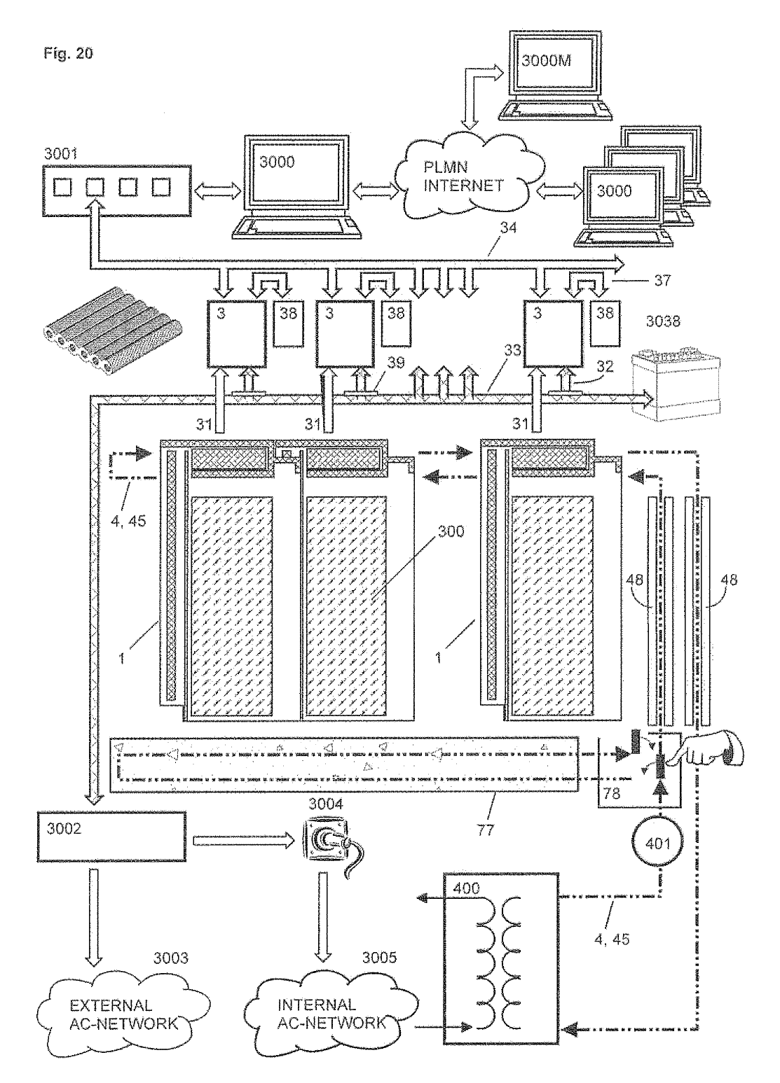

FIG. 20 a block wiring diagram of the inventive energy supply device with energy panels 1 according to FIG. 1, 8, 9, 11 or 14;

FIG. 1 shows an inventive energy supply system with an energy panel 1, which is thermally and mechanically connected to a pipeline 4 of a pipeline system, in which a heat transport medium 45 flows.

The energy panel 1 comprises a structure 5 consisting for example of clay or metal and having an opening 51, into which a plurality of energy modules 300 preferably serving to absorb solar energy and a metal body 2 are inserted. The metal body 2 comprises a cooling element 21 serving to absorb thermal energy, a coupling device 22 serving for coupling to the pipeline 4 and a chamber 23 that can be closed by means of a flap 231 and in which a control unit 3 and two energy storage units 38 are provided. The control unit 3 provided in the chamber 23 is connected via lines 35 to at least one sensor 353 and to at least one signal emitter 352, e.g. a light emitting diode.

In this embodiment of the energy panel 1 the metal body 2, the energy modules 300 and possibly also the sensors 351 and signal emitters 352 are fixed within the opening 51 of the structure 5 at the corresponding positions by means of a casting compound 6 preferably having good thermal conductivity.

The inventive energy panel 1 serves for the output of electrical energy and thermal energy. The electrical energy output by the energy modules 300 is fed via connection lines 31 to the local control unit 3, from which electrical energy is output to the local storage units 38 or via a power supply line 33 to external consumer loads or to an energy converter 3003 that is attached downstream to the power supply line 33.

Furthermore a central control unit 3000 is provided, which communicates via a data bus 34 with the local control units 3. Besides energy management, which is controlled by the central control unit 3000 and the local control units 3, an authentication procedure can also be carried out before the energy panel 1 comes into operation. It can hereby be ascertained whether the central control unit 3000 is authorised to operate the installed energy panels 1. For example passwords are exchanged between the control units 3, 3000 and it is checked whether these correspond to each other. Stolen energy panels 1 can no longer be used therefore at other installation locations and are worthless to the user. The theft of such protected energy panels 1 is therefore not worthwhile.

The power supply lines 33 and the control lines 34 can advantageously be realised as a flat cable, which can be guided particularly advantageously in the recess 47 provided in the pipeline 4 and extending in an axial-parallel way. The flat cable 33, 34 can be provided with connectors, to which a connecting cable 32 can be connected, which connecting cable is guided through an opening 234 in the chamber 23 and connected to the local control unit 3. Flat cables and connecting devices as shown and described in [3], FLACHKABELSYSTEM TECHNOFIL, product description of Woertz A G, Muttenz of May 2004, can be used particularly advantageously. The connection boxes disclosed therein can be placed on the flat cable 33, 34 and can be connected by means of pointer screws to the cores of the flat cable 33, 34 lying in the cable channel 47. A connection box adapted to the pipeline is preferably used.

The current transfer from and to the local storage units 38 and from and to the external consumer loads can be controlled as desired by the local control unit 3. Insofar as lithium ion accumulators are used as storage units 3 the local control unit 3 ensures that they are constantly operated in a favourable work range. The electrical energy obtained can thus be locally stored and be called up by the central control unit 3000 when needed, whereby the optimal operation of the accumulators is ensured.

It is to be noted that with the inventive energy supply device the transfer of electrical and/or thermal energy can be realised in both directions using the central and local control units 3, 3000. For example the locally provided power storage units 38 can be charged by means of electrical energy, which is taken from the public supply network. The installation can thus be installed and operated even if there is insufficient solar radiation. By the transfer of thermal energy to the energy panels 2 the latter can be placed in an ideal operating state, for example being freed from a layer of snow.

The thermal energy 1 absorbed by the energy panel 1 or the thermal energy absorbed by the structure 5 of the energy panel 1 and by the energy modules 300 is absorbed by the metal body 2 serving as a local heat sink, in particular by the cooling element 21 of said metal body 2, which cooling element 21 is drawn for this purpose in a planar manner along the energy modules 300 and the surface of the structure 5. In preferred embodiments the energy modules 300 are screwed to the cooling element 21 in such a way that the metal body 2 and the energy modules 300 form a unit, which can be inserted as a module in the opening 51 of the structure 5 and fixed therein, possibly being screwed, preferably being cast.

The thermal energy obtained is output from the cooling element of the metal body 2 via the coupling device 22 to the pipeline 4. Said pipeline 4 comprises two fluid channels 41, 42, in which a heat transport medium 45 flows back and forth within the pipeline 4 and conveys the supplied thermal energy to a heat exchanger 400 and is fed back from there into the circuit by means of a circulation pump 401.

The pipeline 4 comprises mounting elements in the form of flanges 431, which can be connected with elements of a roof truss or a building wall. FIG. 1 shows that a flange 431 of the pipeline 4 is screwed to a wooden rafter 7 by means of a screw 95. Numerous other assembly possibilities can also be considered and may allow the mounting elements 431 to be omitted. For example a pipeline 4 can be used with a circular cross-section, which pipeline 4 is held by means of a bracket or a fastening element.

FIG. 2 shows in a three-dimensional illustration the metal body 2 of the energy panel 1 of FIG. 1, which comprises the cooling element 21 serving for absorption of thermal energy, the coupling element 22 that can be connected to the pipeline and the chamber 23, of which the inner space 233 serves to receive the control unit 3 and the power storage element 38. The opening 234 provided in the chamber 23 can be clearly seen, through which opening 234 the connecting cable 32 can be routed to the pipeline 4. The cooling element 21 is provided with cooling ribs 211, which serve to absorb thermal energy and for anchoring in the casting compound 5. The arched coupling element 22 comprises at its ends holding ribs 221, which can engage in corresponding holding grooves 48 provided in the pipeline 4. The coupling element 22 can thus be pressed onto the pipeline 4 until the holding ribs 221 engage in the holding grooves 48 (see FIG. 1). In order to release the coupling element 22 the holding ribs 221 must be pulled out of the holding grooves 48. Alternative embodiments are shown in FIGS. 3 and 4.

FIG. 3 shows the metal body 2 of FIG. 2 in a further embodiment, in which the structure 5 of the energy panel 1 is possibly finished integrally from metal, preferably aluminium, and is possibly coated. It is shown that the energy module 300 is mounted by means of a screw 93 and a nut 94, which is held so as to be displaceable between two cooling ribs 211. It is further shown that the arched coupling element 22 is held on only one side with a holding rib 221 in a holding groove 48 of the pipeline 4. On the other side the coupling element 22 and the pipeline 4 are provided with flange elements 29, 49, which can be securely tightened by means of a nut 92 and a screw 91, the screw head of which is held within the chamber 23 and can thus be actuated easily. In this way it is possible to press the coupling element 22 securely against the pipeline 4 in order to achieve a minimal thermal transfer resistance.

While the pipelines 4 shown in FIGS. 1, 2 and 3 are provided with coupling elements FIG. 4 shows a greatly simplified pipeline 4 with a practically circular cross-section. The clamps or buckles 271, 273 fixed thereto, one of which is provided with a coupling plate 272, can thus be rotated as desired and fixed in a desired position using nuts 92 and screws 91, of which the screw heads 91 are in turn held in the chamber 23. The coupling element 22 consists in this case of the multi-part coupling fitting 271, 272, 273. Coupling to the metal body 2 is realised by means of the coupling plate 272, which is pressed against the metal body 2.

The embodiments of the energy panel 1 shown in FIGS. 3 and 4 show that said energy panel 1 can be produced particularly advantageously integrally from metal, in particular aluminium. The fixing of the energy modules is easily possible. On account of the absence of internal cooling medium channels the metal energy panel 1 can be constructed extremely compactly. The structure 5 and/or the metal body 2 are identical in the simplest embodiments of the energy panel 1.

FIG. 5 shows in a three-dimensional illustration a segment of the pipeline 4 of FIG. 1 with the two channels 41, 42 serving to guide the heat transport medium and the axially extending dovetail form recess 47, within which the flat cable 33, 34 is guided.

The course of the heat transport medium 45 is further shown schematically, whereby said heat transport medium 45 enters on the front side into the fluid channel 41 and leaves the fluid channel 42 again. Furthermore a mounting profile 81 is shown, which can be introduced into coupling grooves 432 of two adjacent pipelines 4 and be locked therein by means of screws 812.

FIG. 6 shows elements of the pipeline system with segments of pipelines 4 according to FIG. 2, which can be mechanically connected to each other using mounting profiles 81 and of which the fluid channels 41, 42 can be connected using connecting parts 83, 84, 85 or with supply and drainage lines. As already set out with reference to FIG. 2, the pipelines 4 are provided with at least one coupling groove 432, within which a mounting profile 81 can be held so as to be laterally displaceable and fixed. In this connection the coupling groove 432 preferably comprises a T shaped or dovetail shaped profile. For the purpose of locking the mounting profile 81 said mounting profile 81 is provided with a threaded bore 811, into which a threaded pin preferably provided with a cup point on the front side or a screw 812 can be rotated and pressed against the upper groove surface in such a way that said threaded pin is connected in a force locking way to the body of the pipeline and/or the cup point engages in a shape locking way therein. Connecting parts preferably made of plastic 83, 84, 85 are provided for the connection of the fluid channels 41, 42. Said connecting parts 83, 84, 85 comprise pipe parts, which can be inserted into the fluid channels 41, 42 so as to provide a sealed termination. The first connecting part 83, which serves to connect two pipelines 4, comprises for each of the at least two fluid channels 4, 42 a pipe part or two pipe parts corresponding to each other, which are possibly connected to each other by means of a plate. Said plate preferably has the same cross-section as the pipeline 4. For the purpose of connection of the fluid channels 41, 42 the second connecting part 84 is provided, which comprises two pipe parts connected to each other and orientated in an axial-parallel way. After the insertion of the second connecting part 84 the two fluid channels 41, 42 of the pipeline 4 thus form a single, continuous fluid channel, which enters into the pipeline and leaves again at the same side. Third connecting parts 85 are provided at the input and output points. In order to hold the second and/or third connecting parts 84, 85 inserted into the pipeline 4 an angle profile 82 provided with a threaded bore 821 is provided, which angle profile 82 can be introduced into the coupling groove 432 and fixed by means of a screw 821.

FIG. 7 shows a preferably formed pipeline 4 with a profile with two pipe parts 410, 420 connected to each other via a base structure 400. The first and/or second fluid channel 41, 42 are guided in said pipe parts 410, 420, whereby on the first pipe part 410 a first profile part 470 guiding the cable channel 47 is arranged and on the second pipe part 420 a carrier plate 480 is arranged and against the upper side of which the energy panels 1 can lie in a planar manner. In this embodiment the pipeline 4 serves in particular for the installation of energy panels of FIG. 14. The energy panels 1 present in the form of a roof tile lie planar against the carrier plate 480 and thereby transfer thermal energy from the energy panel 1 to the pipeline 4. An additional direct electrical and thermal connection between the metal substrate 301 of the energy module 300 and the pipeline 4 is preferably achieved by using a coupling element 22, for example a metal band, which is guided in a channel 591 of the tile structure 5. While the energy module 300 to be installed lies on the carrier plate 480 and is held for example by means of a nose element 54 provided on the lower side of the tile structure, the cable guiding channel 47 still lies free, so that the electrical connection of the energy panel 1 to the power line and the possibly present control lines 33, 34 can be carried out simply.

It is further shown in FIG. 7 that a mounting profile 8 is provided in the coupling groove 432 provided in the base structure 400 of the pipeline 4, by which mounting profile 8 the pipeline 4 is held or adjacent pipelines 4 are held. The mounting profile 8, for example an extruded aluminium profile of selectable length, is connected by mounting screws 95 to the beams of the roof truss. The use of the mounting profile 8 allows the simple and precise assembly of the pipeline system. In a first step the mounting profiles 8 are precisely orientated and mounted. The pipelines 4 are then hung in the mounting profiles 8.

FIG. 8 shows two energy panels 1 each connected to a pipeline 4 in a first embodiment. In the upper energy panel 1 the flap 231 of the chamber 23 has been opened. Provided in the chamber 23 are two energy storage elements 38 and the local control unit 3, which is connected via the connection cable 32 and a connector 39 to the flat cable 33, 34 guided in the pipeline 4. The electrical coupling to the flat cable 33, 34 can take place particularly simply if said flat cable 33, 34 is guided out of the recess 47 provided in the pipeline 4 and guided into the chamber 23 provided in the metal body 2. The recess 47 and the opening 234 in the chamber 23 are to be adapted in the manner of the person skilled in the art.

It is further shown in FIG. 8 that the upper energy panel 1 overlaps the lower energy panel 1 in such a way that the chamber 23 there is completely overlapped. Only the energy modules 300 are thus visible from above, of which one energy module has been removed in order to allow a view into the opening 51 of the structure 5 of the energy panel 1. By the integration of the chamber 23 into the energy panel 1 there is thus no loss of surface that can be covered with energy modules.

FIG. 9 shows an energy panel 1 connected to a pipeline 4 in a second embodiment. It is shown that the metal body 2 has been removed (see FIG. 2) so that the opening 51 in the structure 5 of the energy panel 1 lies free. It is shown that the structure comprises laterally edge termination elements 55, 56, which correspond to edge termination elements 56/55 of adjacent energy panels 1. In the region of the chamber 23 below the opening 51 a termination element 57 is further provided, which is overlapped by the next highest energy panel 1 and prevents rainwater coming from here from penetrating the chamber 23.

FIG. 10 shows a plurality of energy panels 1 according to FIG. 9 mounted on pipelines 4 on a roof, whereby the edge termination elements 55, 56 of said energy panels 1 overlap each other. Also overlapped are the termination elements 57 of the bottom row of energy panels 1. The termination elements 57 of the upper row of energy panels 1 are overlapped by ridge termination tiles 100.

A further advantageous embodiment of the inventive energy panel 1 is shown in FIG. 11. In this embodiment the energy module 300 can be introduced into holding elements 58, for example guiding grooves, in such a way that its front-side end element 321, after complete insertion of the energy module 300, completely overlaps the chamber 23 and closes it. The energy module 300 and/or its end element 331 thus serves simultaneously as a closing slide for the chamber 23.

In order that the electrical contact with the local control unit 3 can take place automatically after insertion of the energy module 300, contact strips 303, 304 are provided on the energy module 300 and in the chamber 23. Said contact strips 303, 304 lie against each other in the end position of the energy module 300.

The modular structure of the energy panel 1 of FIG. 10 results in a technically and economically advantageous solution. The assembly and maintenance of the energy panels 1 and thus of the whole energy supply system are possible with minimal resources. Insofar as for example one of the energy modules 300 fails, this is displayed by the corresponding signal emitter, for example a light emitting diode 352. The technician can subsequently remove the defective energy module 300 with few hand grips and replace it with a new one.

FIG. 12 shows the structure 5 of a roof tile, upon which an energy module 300 can be placed. The roof tile has features of a conventional roof tile, which allow a roof to be covered with such roof tiles 5. It is shown that the structure laterally comprises edge termination elements 55, 56, which correspond to edge termination elements 56/55 of adjacent energy panels 1. It is further shown that a rib 531 is provided on the lower side of the lower end of the roof tile 5, which rib 531 can engage in a recess 532 on the upper side of the upper end of the roof tile 5. A nose element 54 is further provided on the lower side at the upper end of the roof tile 5, which nose element 54 can engage in the roof lathing. For example the nose element 54 of the roof tile 5 engages over the carrier plate of the pipeline of FIG. 7, as shown in FIG. 18. The roof tile of FIG. 12 can thus be used as a replacement for conventional roof tiles.

The tile structure 5 additionally comprises a recess 50 for an energy module 300. The recess 50 is laterally delimited by two guide strips 58 and comprises on the upper side a holding rib 39, which serves to hold the metal body 301 of the energy module 300. Furthermore a cable channel 591 is provided, through which the connecting cable 32 of the energy module 300 and possibly a coupling element 22 can be guided upwardly.

FIG. 13 shows the roof tile 5 of FIG. 12 during the assembly of the energy module 300, which comprises a metal substrate 301, on the upper end of which a metal frame 3011 with an opening 3012 is provided, into which opening 3012 the holding rib 59 is introduced. On the lower side the metal substrate 301 comprises a downwardly bent tongue, which can engage the lower end of the roof tile 5. A layer 302 with electrical components is provided on the metal substrate 301. The local control unit 3, solar cells 333 connected in series, and also light diodes 352, using which the status of the energy panel 1 can be detected, are shown. The light emitting diodes 532 are preferably provided on the lower end of the energy panel 1, which lies free after installation.

FIG. 14 shows the energy panel 1 formed by the roof tile 5 and the energy module 300 connected thereto. It is shown that the tile structure 5 and the energy module 300 are optimally adapted to each other. Even after finished production of the energy panel 1 it could be used as a replacement for a conventional roof tile.

FIG. 15 shows the energy module 300 of FIG. 13 in an exploded view. It is shown that the metal substrate 301 has already been prepared for connection to the tile structure 5. Conductor paths are provided on an insulation layer, by which conductor paths the solar cells 333 and the light emitting diodes 352 are electrically connected. Furthermore the energy module 300 is covered with a preferably non-slip protective layer 305.

FIG. 16 shows two energy modules 300 according to FIG. 13, which can be electrically connected by means of connecting lines 32 and a respective connector 39 to a power supply line 33 and control lines 34, which are preferably integrated in a flat cable. As mentioned, a connection element known from [3] can be used as a connector 39, which connection element is inserted into a connection box 390. The electrical contact is for example produced in that metal screws are rotated into the cores of the flat cable 33, 34.

Furthermore band-form coupling elements 22 made of metal are shown, as coupled on the one hand to the metal substrate 301 of the energy module 300 and on the other hand to the pipeline 4. It is possible to use coupling elements 22 that are formed integrally on the metal substrate 301. Furthermore clamps, buckles, brackets and further mounting means such as flange elements, contact plates and screws can be used in order to mount the coupling elements 22 at both ends. The mounting of the coupling elements 22 results not only in a thermal but also in an electrical connection between the metal bodies 301 of the energy panels 1 and the preferably earthed pipeline 1, so that not only a good thermal connection but also protection against radiation and lightning are ensured.

FIG. 17 shows a preferable embodiment of the pipeline 4 of FIG. 7 with two cable channels 47 which serve for separate guiding of power lines 33 and control lines 34. A separate cable channel can be advantageous if for example a bus system is to be realised. Also shown are connecting elements 83 and 84, by means of which the two fluid channels 41 and 42 are connected to each other.

FIG. 18 shows pipelines 4 according to FIG. 7 mounted on a roof, which pipelines 4 form the roof lathing, on which energy panels 1 are arranged. It is shown that the tile structure 5 of the energy panels 1 lies with a flat lower side 500 planar against the carrier plates 480 and engages over them with a nose element 54. The cable channel 47, in which the power lines 33 and control lines 34 are placed, is on the other hand arranged above the supported energy panel 1. As a result the electrical connection between said lines 33, 34 and the energy panel 1 can be carried out without problems during installation. The cable channel 47 is only subsequently covered by a further energy panel 1.

FIG. 19 shows the roof level 70 of a building, on which inventive energy panels 1 are installed. It can be clearly seen that the pipelines 4 connected to the roof beams 7 form the roof lathing, upon which the energy panels 1 are placed in the manner described above.

As mentioned in connection with FIG. 7, preferably firstly the mounting profiles 8 are connected to the roof beams 7. Individual segments or profiles extending over the whole roof truss can thereby be used. Subsequently the pipelines 4 are hung in the mounting profiles 7.

FIG. 20 shows a block wiring diagram of the inventive energy supply device with energy panels 1 according to FIG. 1, 8, 9, 11 or 14. It is shown in the top half of the drawing that the central control unit 3000, which is preferably connected to the Internet or a mobile radio network PLMN, is connected via a network module 3001 and the data lines 34 to the local control units 3. The central control unit 3000, for example a personal computer, can thus also be controlled via the mobile radio network or the Internet. For example meteorological data are transmitted to the central control unit 3000, by reference to which the energy management of the local energy supply system or the energy supply device is controlled. Furthermore a schedule with times at which the energy obtained can be output to the public network under the best possible conditions can be notified to the central control unit 3000. A plurality of local energy supply systems can for example also be coordinated by a super-ordinate control unit 3000M, which is in connection with an operator of a public network and can negotiate with it optimal conditions for the supply of electrical energy. The administration for all local energy supply systems can be assumed in this case by the super-ordinate control unit 3000M. The operator of a local energy supply system is relieved of the burden of corresponding expenditure. Quantities of energy output to the public network are locally measured and reported to the central control unit 3000 and charged by it.

FIG. 20 further shows that the heat transport medium can be conveyed via a changeover switch 78 also through a cooled region, for example the earth region 77 or the downhole heat exchanger of a heat pump. In summer the roof of the building can thus be cooled by means of the cooled heat transport medium, so that further cooling devices are superfluous.

The local control units 3 are for their part connected via connecting lines 31 to the energy modules 300, via connecting lines 37 to the local control units 38 and via connecting lines 32 and a connector 39 to the power supply line 33. The power supply lines 33 are on the one hand connected to an optionally provided central accumulator 3038 and on the other hand to an optionally provided energy converter 3002, which can output an alternating current to an external or internal alternating current network 3003, 3005 and corresponding connection boxes 3004. It is shown schematically that the power supply lines 33 and data lines and/or control lines 34 can be realised with a flat cable. Furthermore the circuit realised by means of the pipeline system for the heat transport medium 45 is schematically shown. It is further shown that the elements of the pipeline system are preferably provided with thermally insulating materials 48 so that no energy losses arise on the transport path.

Preferred embodiments of the invention are described in the individual embodiments. The features thereof can, however, be combined with each other in principle.

Literature
[1] JP 2005 241021 A
[2] EP 0 335 261 B1
[3] FLACHKABELSYSTEM TECHNOFIL, Product Description of Woertz A G, Muttenz, May 2004

1. Energy supply device with a plurality of energy panels provided as roof tiles, which energy panels cover a part of a building and comprise each an energy module that is serving to absorb solar energy and that is connected to a power supply line, wherein at least one metal pipeline is provided on an outer side of the building, which metal pipeline supports the energy panels, which are mechanically and thermally connected to the pipeline, which comprises a cable channel, serving to receive the power supply line, and at least one fluid channel, through which a fluid heat transport medium can be conveyed, with which thermal energy can be transferred from the energy panel to a thermal energy sink.

2. Energy supply device according to claim 1, wherein a plurality of pipelines produced from aluminium, which are mounted parallel to each other on the roof truss of the building, form a roof lathing serving to support the roof tiles, and in that the pipeline comprises a first fluid channel, in which the heat transport medium is guided in one direction, and a second fluid channel, in which the heat transport medium is returned.

3. Energy supply device according to claim 1, wherein each energy panel comprises a connecting cable connected to the energy module having a connector, which can be connected to a flat cable guided in the cable channel, which flat cable includes the power supply line and/or control lines, wherein the individual energy modules are preferably connected to each other in parallel by the power supply line.

4. Energy supply device according to claim 1, wherein the pipeline comprises a profile with two pipe parts connected to each other via a base structure, in which pipe parts the first and second fluid channels are respectively guided, whereby on the first pipe part a first profile part forming the cable channel is arranged and on the second pipe part a carrier plate is arranged, against the upper side of which the energy panels lie planar.

5. Energy supply device according to claim 1, wherein a coupling device is provided, which is connected on the one hand to a metal body of the energy panel and on the other hand to the pipeline, whereby a thermal and/or mechanical connection is produced.

6. Energy supply device according to claim 1, wherein at least one of the energy panels is provided with a local control unit, which is connected via control lines to a central control unit and which is adapted to control the current output by the energy module to at least one local current collector provided in the energy panel, a power storage unit or light emitting diodes, or to at least one central current collector.

7. Energy supply device according to claim 1, wherein the pipelines are provided on the lower side thereof with a coupling groove, in which a mounting profile is fixedly or displaceably held, by which the pipelines are connected to each other and/or to the roof truss.

8. Energy panel in the form of a roof tile, in particular for an energy supply device according to claim 1, with an energy module serving to absorb solar energy, which energy module can be connected via a connecting line to a power supply line, wherein a tile structure made of clay or metal in the form of a roof tile is provided, on the upper side of which a receiving area for the energy module is provided, which energy module comprises a metal body in the form of a metal plate, which is releasably connected to the tile structure and on which solar cells are arranged.

9. Energy panel according to claim 8, wherein the tile structure comprises at least one holding element, which holds the energy module in a shape-locking way and/or in that the tile structure comprises a cable channel, in which the connecting line is laid.

10. Energy panel according to claim 8, wherein the tile structure comprises on the bottom side a flat zone, which corresponds to a plate-form carrier element of the pipeline.

11. Energy panel according to claim 9, wherein the metal body comprises at the upper end a frame with an opening, into which one of the holding elements engages, and/or in that the metal body comprises at the lower end a preferably bendable tongue element, which engages around the lower end of the tile structure.

12. Energy panel according to claim 8, wherein the energy module comprises at least one local current collector, such as a local energy storage unit and/or at least one light emitting diode, which serves as a consumer load and/or signal emitter.

13. Energy panel according to claim 8, wherein the energy module comprises at least one local control unit, which can be connected via control lines to a central control unit and is adapted to control the current output by the energy module on the one hand towards the local current collector or towards at least one central current collector.

14. Energy panel according to claim 8, wherein the energy module is structured as a laminate, with the metal body as a substrate layer, on which a functional layer covered by a transparent protective layer is arranged, on which functional layer the local control unit and also solar cells and possibly the light emitting diodes, which are not covered by further energy modules, are arranged.

15. Energy panel according to claim 8, wherein the local control unit is designed or connectable in such a way that the energy module, after disconnection of the energy panel from the power line, is connected to the light emitting diodes, which consume the energy generated and simultaneously indicate the status of the energy panel.

16. Roof tile, in particular made of clay, for an energy panel according to claim 8.
